(19) United States
(12) Patent Application Publication
(10) Pub. No.: US 2009/0224737 A1
(43) Pub. Date: Sep. 10, 2009

(54) VOLTAGE REGULATOR WITH LOCAL FEEDBACK LOOP USING CONTROL CURRENTS FOR COMPENSATING LOAD TRANSIENTS

(75) Inventor: Chih-Hong Lou, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/044,016

(22) Filed: Mar. 7, 2008

(51) Int. Cl. G05F 1/00

(52) U.S. Cl. 323/280

(57) ABSTRACT

A voltage regulator with a local feedback loop is disclosed, which provides adaptive control currents responsive to load transient to regulate abrupt voltage variations. The voltage regulator has an amplifier having a first input coupled to a reference voltage, a second input coupled to a feedback signal, and an output producing a first control signal; an output transistor having a control input, a first electrode coupled to a supplied voltage, and a second electrode coupled to an output terminal to output a regulated output voltage; a feedback circuit coupled to the output terminal to produce the feedback signal; and an adaptive biasing device coupled to the output terminal and the control input of the output transistor, for outputting control currents responsive to variations in the regulated output voltage to drive the output transistor to compensate the variations.

### BACKGROUND OF THE INVENTION

1. Field of the Invention

The invention relates to a voltage regulator, and in particular to a voltage regulator with a local feedback loop providing adaptive control currents responsive to load transient to regulate abrupt voltage variations.

2. Description of the Related Art

FIG. 1 shows a conventional linear voltage regulator. The voltage regulator 100 comprises an error amplifier 102, a voltage buffer (or level shifter) comprising a constant current source 104 and a PMOS transistor 106, an output transistor (power PMOS transistor) 108, a feedback circuit comprising resistors R₁ and R₂, and an output capacitor CL. The feedback circuit (R₁, R₂), error amplifier 102, voltage buffer (104, 106) and output transistor 108 constitute a feedback loop. Here, the current source 104 provides constant current Ia. The voltage regulator 100 relies on the output capacitor CL and the feedback loop to handle load transients and compensate variations in the output voltage Vₒᵤₜ of the voltage regulator 100.

Generally, handheld or mobile electronic systems demand lower operating currents to save power and smaller output capacitors to reduce cost and system dimension. Small capacitors like 0204-type capacitors are widely used to shrink bulk of the voltage regulators in handheld or mobile electronic systems. However, low operating currents and small output capacitors both degrade performance of voltage regulators. Increasing the current of the constant current source 104 can accelerate feedback loop response of the voltage regulator 100, but without satisfying lower operating current and power saving required by handheld or mobile electronic systems.

FIG. 2 shows another conventional voltage regulator as disclosed in U.S. Pat. No. 6,157,176. The voltage regulator 200 provides a local feedback loop of load transient suppression to achieve quick response to load transients. The voltage regulator 200 uses an amplifier OP2 to compare an output voltage VOUT through a resistor R3 and a first voltage V1 from a low-pass filter comprising resistor R4 and capacitor C1. The amplifier OP2 amplifies difference of the output voltage VOUT and the first voltage V1 to change current Itr, thereby speeding charging/discharging of an amplifier OP1 and accelerating response of the local feedback loop. However, such local feedback loop of the voltage regulator 200 only works for suppressing overvoltage of the output voltage VOUT, i.e., merely compensating load transient from heavy to light.

FIG. 3 shows another conventional voltage regulator as disclosed in U.S. Pat. No. 6,188,211. The voltage regulator 300 uses PNP bipolar junction transistors 16 and 18, NMOS transistors 20, 22 and 35, and PMOS transistor 12 forming a local feedback loop of load transient suppression. The voltage regulator 300 provides a current path to quickly discharge the PMOS transistor 12 through the NMOS transistor 35 of the local feedback loop when loading of the voltage regulator 300 changes from light to heavy. Resistor 32, capacitor 30 and NMOS transistor 28 jointly operate to improve load regulation performance based on a main feedback loop of the resistors 40 and 42, amplifier 38 and PMOS transistor 12. Similarly, such local feedback loop of the voltage regulator 300 only works for suppressing undervoltage of the output voltage V_{OUT} and compensating load transient from light to heavy. In addition, the voltage regulator 300 comprises PNP bipolar transistors 16 and 18, being incompatible with CMOS process.

### BRIEF SUMMARY OF INVENTION

An object of the invention is to provide a voltage regulator with a local feedback loop capable of responding to variations in regulated output voltage and adaptively providing control currents to quickly compensate the variations or load transients.

To achieve the object, the invention provides a voltage regulator which comprises an amplifier having a first input coupled to a reference voltage, a second input coupled to a feedback signal, and an output producing a first control signal; an output transistor having a control input, a first electrode coupled to a supplied voltage, and a second electrode coupled to an output terminal to output a regulated output voltage; a feedback circuit coupled to the output terminal to produce the feedback signal; and an adaptive biasing device coupled to the output terminal and the control input of the output transistor, for outputting control currents responsive to variations in the regulated output voltage to drive the output transistor to compensate the variations. The adaptive biasing device further comprises a transconductance amplifier having at least a first input coupled to the output terminal, a second input and an output coupled to the output transistor; and a transient rejection device having an input coupled to the output terminal and an output coupled to the second input of the transconductance amplifier, for rejecting variations in the regulated output voltage.

Another exemplary embodiment of the invention provides a voltage regulator comprises an amplifier having a first input coupled to a reference voltage, a second input coupled to a feedback signal, and an output producing a first control signal; an output transistor having a control input, a first electrode coupled to a supplied voltage and a second electrode coupled to an output terminal to output a regulated output voltage; a control transistor having a first electrode coupled to the control input of the output transistor, a second electrode coupled to a ground voltage and a control input coupled to the output of the amplifier; a feedback circuit coupled to the output terminal to produce the feedback signal; a first transistor having a control input, a first electrode and a second electrode, wherein the second electrode is coupled to the control input; a second transistor having a control input coupled to the control input of the first transistor, a first electrode coupled to the first electrode of the first transistor and a second electrode coupled to the control input of the output transistor; a current source for providing a bias current; a third transistor having a control input coupled to the output terminal, a first electrode coupled to the current source and a second electrode coupled to the second electrode of the first transistor; a fourth transistor having a control input, a first electrode coupled to the current source and a second electrode coupled to the second electrode of the second transistor; and a low-pass filter coupled between the output terminal and the control input of the fourth transistor.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a conventional voltage regulator.

FIG. 2 shows another conventional voltage regulator as disclosed in U.S. Pat. No. 6,157,716.

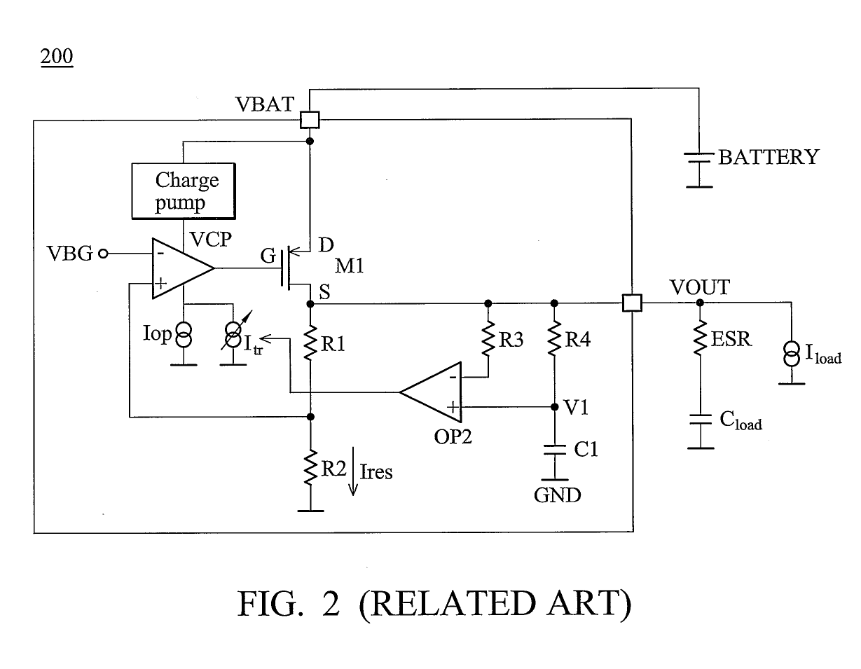

FIG. 3 shows another conventional voltage regulator as disclosed in U.S. Pat. No. 6,188,211.

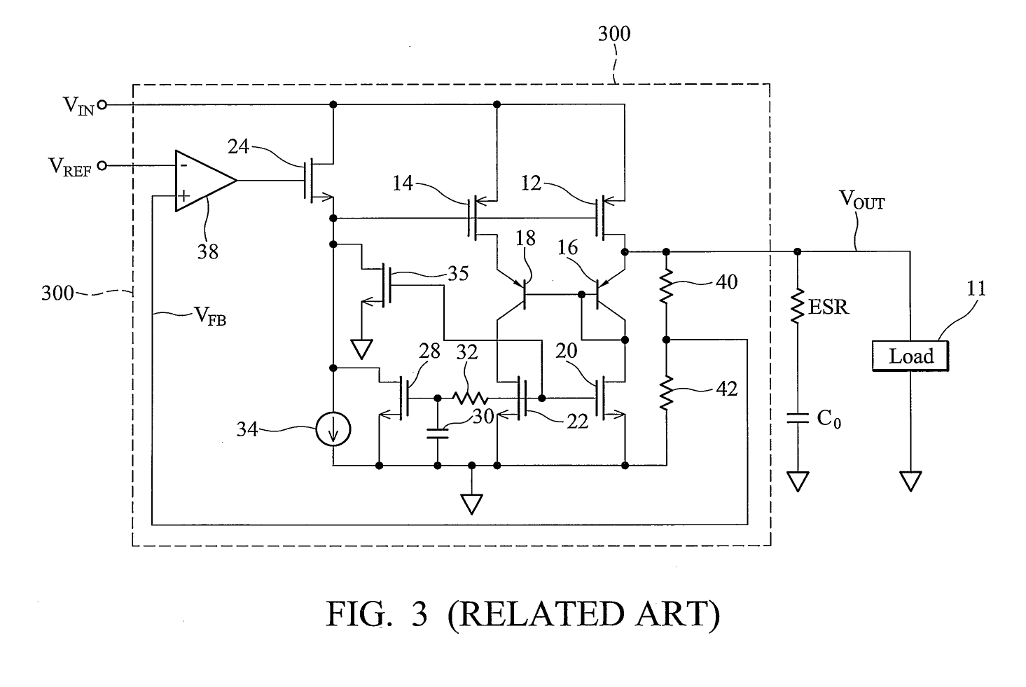

FIG. 4 shows an exemplary embodiment of the invention.

FIG. 5 shows another exemplary embodiment of the invention.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

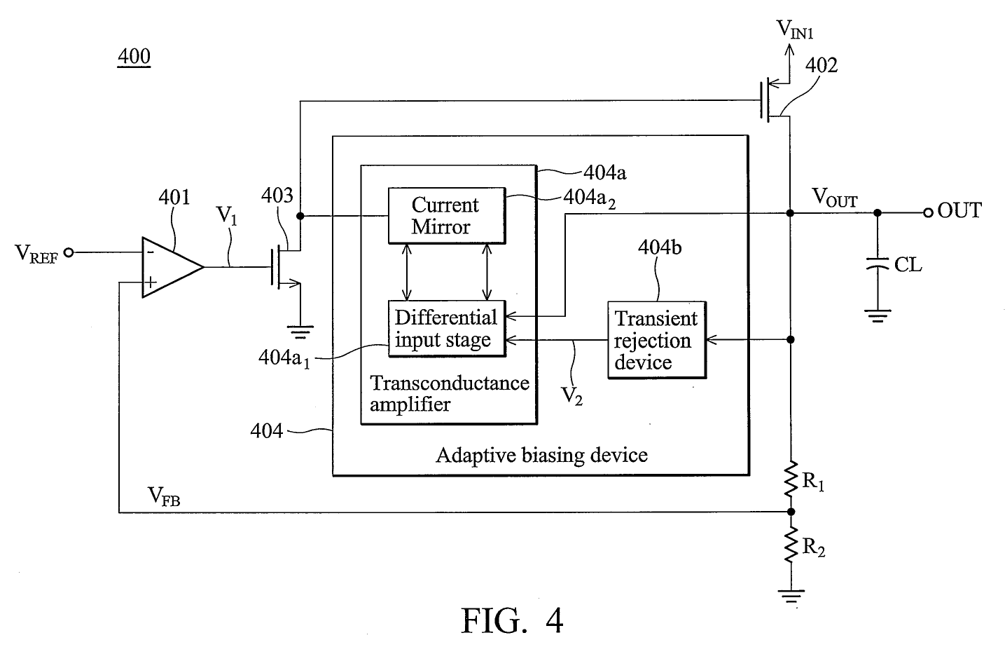

FIG. 4 is a circuit block diagram of a voltage regulator 400 according to an exemplary embodiment of the invention. The voltage regulator 400 comprises an amplifier (e.g. error amplifier 401), an output transistor 402, a feedback circuit of resistor R₁ and R₂, a control transistor 403, an adaptive biasing device 404, and an output capacitor CL. The feedback circuit of R₁ and R₂, coupled to an output terminal OUT of the voltage regulator 400, serves as a voltage divider to generate a feedback signal V_{FB} by voltage division of a regulated output voltage V_{OUT}. The error amplifier 401 has a first input (−) coupled to a reference voltage V_{REF}, a second input (+) coupled to the feedback signal V_{FB}, and an output producing a first control signal V₁. The control transistor 403, coupled between the error amplifier 401 and the output transistor 402, performs level shifting to the first control signal V₁. The output transistor 402 has a control input coupled to the control transistor 403, a first electrode coupled to a supplied voltage V_{IN1}, and a second electrode coupled to the output terminal OUT to output the regulated output voltage V_{OUT}. The control transistor 403 having a first electrode coupled to the control input of the output transistor 402, a second electrode coupled to a ground voltage (e.g. a signal ground), and a control input coupled to the first control signal V₁. The adaptive biasing device 404, coupled to the output terminal OUT and the control input of the output transistor 402, outputs control currents responsive to variations in the regulated output voltage V_{OUT} at the output terminal OUT to drive the output transistor 402 for quick compensation of the variations. Here, the output transistor 402 is a power PMOS transistor and the control transistor 403 is a PMOS transistor.

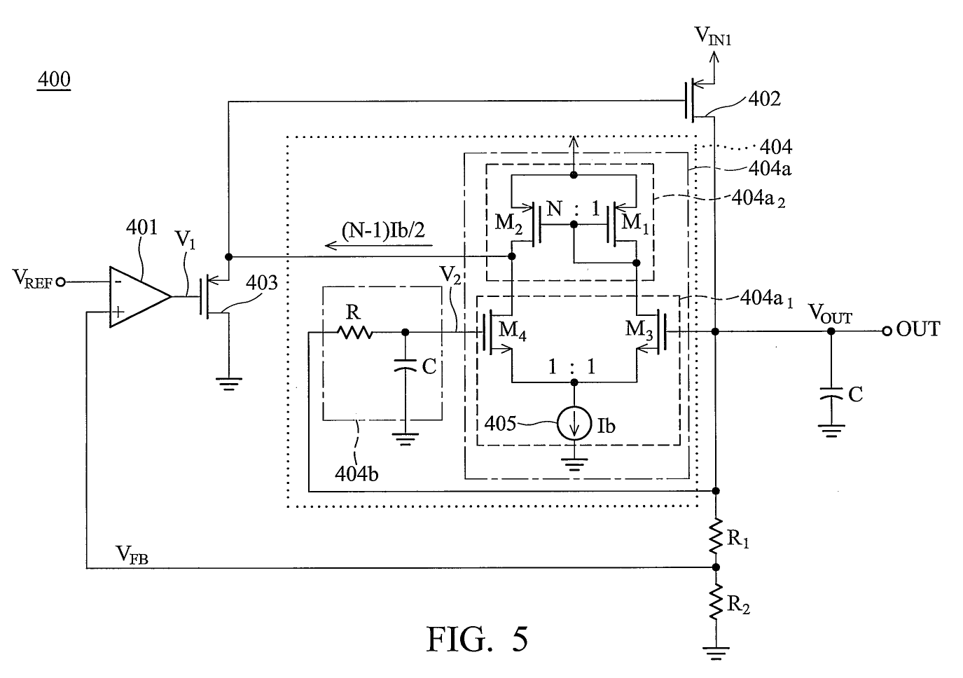

The adaptive biasing device 404 comprises a transconductance amplifier 404a and a transient rejection device 404b. The transconductance amplifier 404a comprises a differential input stage 404a₁ which may be biased by a current source, and a current mirror 404a₂ coupled to the differential input stage 404a₁. The transient rejection device 404b receives the regulated output voltage V_{OUT} and generates a voltage V₂ regardless of the variations in the regulated output voltage V_{OUT}. Therefore, the transconductance amplifier 404a outputs control currents responsive to the variations in the regulated output voltage V_{OUT}, i.e. the difference between the voltage V₂ and the regulated output voltage V_{OUT}. Detailed operation of the transconductance amplifier 404a is as follows, with FIG. 5, showing a detailed circuit of the voltage regulator 400 in FIG. 4.

FIG. 5 shows a detailed circuit of the voltage regulator 400 depicted in FIG. 4. The transient rejection device 404b is a low-pass filter comprising a resistor R and a capacitor C. The current mirror 404a₂ comprises a first transistor M₁ and a second transistor M₂ of which the size is as large as N times that of the first transistor M₁, where N is greater than 1. In the example, the first transistor M₁ and second transistor M₂ are PMOS transistors. The differential input stage 404a₁, biased by a constant current source 405, comprises a third transistor M₃ having a control input coupled to the output terminal OUT, a first electrode coupled to the constant current source 405 and a second electrode coupled to the first transistor M₁; and a fourth transistor M₄ having a control input coupled to the transient rejection device 404b, a first electrode coupled to the constant current source 405 and a second electrode coupled to the second transistor M₂. Here, the third transistor M₃ is as large as the fourth transistor M₄ and both are NMOS transistors.

The constant current source 405 provides a constant current Ib, and the transconductance amplifier 404a thus equivalently biases the control transistor 403 and the output transitor 402 with a DC current of

$$\frac{( N - 1 )}{2} Ib .$$

When the regulated output voltage V_{OUT} suffers an overvoltage transient, the currents in the third and fourth transistors M₃ and M₄ become

$$\frac{1}{2} Ib + \frac{1}{2} Δ I and \frac{1}{2} Ib - \frac{1}{2} Δ I ,$$

respectively. The current variation

$$\frac{Δ I}{2}$$

due to overvoltage is amplified N times by the current mirror 404a₂ and therefore the transconductance amplifier 404a biases the control transistor 403 and the output transistor 402 with a current of

$$\frac{( N - 1 )}{2} Ib + \frac{( N + 1 )}{2} Δ I .$$

The transconductance amplifier 404a uses the current of

$$\frac{( N - 1 )}{2} Ib + \frac{( N + 1 )}{2} Δ I$$

charging the gate of the output transistor 402 so as to compensate the overvoltage of the regulated output voltage V_{OUT}. It is noted that if the overvoltage of the regulated output voltage V_{OUT} is high enough that the third transistor M₃ is fully turned on to flow current Ib, the current charging the output transistor 402 may become N×Ib, thereby achieving quick compensation of the overvoltage.

Similarly, when the regulated output voltage V_{OUT} suffers an undervoltage transient, the currents in the third and fourth transitors M₃ and M₄ become

$$\frac{1}{2} Ib - \frac{1}{2} Δ I and \frac{1}{2} Ib + \frac{1}{2} Δ I$$

respectively. The current variation

$$\frac{Δ I}{2}$$

due to undervoltage is amplified N times by the current mirror 404a₂ and therefore the transconductance amplifier 404a biases the control transitor 403 and the output transitor 402 with a current of

$$\frac{( N - 1 )}{2} Ib - \frac{( N + 1 )}{2} Δ I .$$

The transconductance amplifier 404a uses the current of

$$\frac{( N - 1 )}{2} Ib - \frac{( N + 1 )}{2} Δ I$$

discharging the gate of the output transistor 402 so as to quickly compensate the undervoltage of the regulated output voltage V_{OUT}. It is noted that if the undervoltage of the regulated output voltage V_{OUT} is low enough that the third transistor M₃ has no current therethrough, the current discharging the output transistor 402 may become Ib. Therefore, when undervoltage of the regulated output voltage V_{OUT} occurs, the output transistor 402 can be discharged by the discharge current Ib in addition to a current through the control transistor 403, thereby achieving quick compensation of the undervoltage.

In view of the descriptions, the adaptive biasing device 404 operates to push or pull currents for charging or discharging the output transistor 402 according to variations (overvoltage or undervoltage) in the regulated output voltage V_{OUT}, thereby providing a quickly responsive local feedback loop for voltage regulation.

In addition, the control transistor 403 is equivalently biased by DC current

$$\frac{( N - 1 )}{2} Ib ,$$

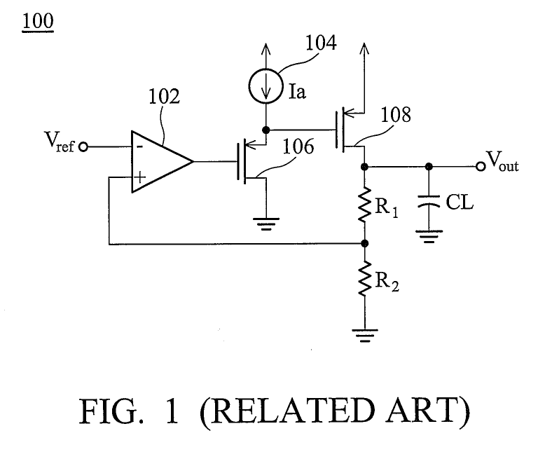

compared with the control transistor 106 in FIG. 1 which is simply biased by DC current Ia from the current source 104. When similar currents are used to bias the control transistors 106 and 403, current Ib provided by the constant current source 405 can be lower than the current Ia provided by the current source 106 and therefore efficiently reduce bias current of the constant current source 405 while maintaining required load transient response.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A voltage regulator, comprising:
an amplifier having a first input coupled to a reference voltage, a second input coupled to a feedback signal, and an output producing a first control signal;
an output transistor having a control input, a first electrode coupled to a supplied voltage, and a second electrode coupled to an output terminal to output a regulated output voltage;
a feedback circuit coupled to the output terminal to produce the feedback signal; and
an adaptive biasing device coupled to the output terminal and the control input of the output transistor, outputting control currents responsive to variations in the regulated output voltage to drive the output transistor to compensate the variations, wherein the adaptive biasing device comprises:
a transconductance amplifier having a first input coupled to the output terminal, a second input, and an output coupled to the control input of the output transistor; and
a transient rejection device having an input coupled to the output terminal and an output coupled to the second input of the transconductance amplifier, for rejecting variations in the regulated output voltage.

2. The voltage regulator as claimed in claim 1, wherein the transconductance amplifier comprises:
a differential input stage biased by a bias current; and
a current mirror coupled to the differential input stage, comprising a first transistor and a second transistor, wherein the second transistor is arranged to provide a current N times that flowing through the first transistor, where N is greater than 1.

3. The voltage regulator as claimed in claim 2, wherein a size of the second transistor is larger than a size of the first transistor.

4. The voltage regulator as claimed in claim 2, wherein the differential input stage comprises two transistors of the same size coupled to the regulated output voltage and the transient rejection device, respectively.

5. The voltage regulator as claimed in claim 2, wherein the differential input stage further comprises a current source for providing the bias current.

6. The voltage regulator as claimed in claim 2, wherein the output transistor, the first transistor, the second transistor and the control transistor are PMOS transistors.

7. The voltage regulator as claimed in claim 1, further comprising a control transistor having a first electrode coupled to the control input of the output transistor, a second electrode coupled to a ground voltage and a control input coupled to the first control signal.

8. The voltage regulator as claimed in claim 1, wherein the transient rejection device is a low-pass filter.

9. The voltage regulator as claimed in claim 1, wherein the feedback circuit is a voltage divider for producing the feedback signal by voltage division of the regulated output voltage.

10. A voltage regulator, comprising:
an amplifier having a first input coupled to a reference voltage, a second input coupled to a feedback signal, and an output producing a first control signal;
an output transistor having a control input, a first electrode coupled to a supplied voltage and a second electrode coupled to an output terminal to output a regulated output voltage;
a control transistor having a first electrode coupled to the control input of the output transistor, a second electrode coupled to a ground voltage and a control input coupled to the output of the amplifier;
a feedback circuit coupled to the output terminal to produce the feedback signal;
a first transistor having a control input, a first electrode and a second electrode, wherein the second electrode is coupled to the control input;
a second transistor having a control input coupled to the control input of the first transistor, a first electrode coupled to the first electrode of the first transistor and a second electrode coupled to the control input of the output transistor;
a current source for providing a bias current;
a third transistor having a control input coupled to the output terminal, a first electrode coupled to the current source and a second electrode coupled to the second electrode of the first transistor;
a fourth transistor having a control input, a first electrode coupled to the current source and a second electrode coupled to the second electrode of the second transistor; and
a low-pass filter coupled between the output terminal and the control input of the fourth transistor.

11. The voltage regulator as claimed in claim 10, wherein the second transistor is arranged to provide a current N times that flowing through the first transistor, where N is greater than 1.

12. The voltage regulator as claimed in claim 10, wherein a size of the second transistor is larger than a size of the first transistor.

13. The voltage regulator as claimed in claim 10, wherein the third transistor is as large as the fourth transistor.

14. The voltage regulator as claimed in claim 10, wherein the current source is a constant current source.

15. The voltage regulator as claimed in claim 10, wherein the low-pass filter comprises a capacitor connected to the control input of the fourth transistor and a first resistor connected between the output terminal and the control input of the fourth transistor.

16. The voltage regulator as claimed in claim 15, wherein the feedback circuit comprises a second resistor and third resistors connected in series for producing the feedback signal by voltage division of the regulated output voltage.

17. The voltage regulator as claimed in claim 10, wherein the output transistor, the first transistor, the second transistor and the control transistor are PMOS transistors, and the third and fourth transistors are NMOS transistors.
